(19) United States
(12) Patent Application Publication
(10) Pub. No.: US 2009/0104896 A1
(43) Pub. Date: Apr. 23, 2009

(54) UNIVERSAL SERVICE CODE FOR RESERVATIONS

(75) Inventor: Pawel Demczuk, Warsaw (PL)

Correspondence Address: MARSH, FISCHMANN & BREYFOGLE LLP, 8055 East Tufts Avenue, Suite 450, Denver, CO, 80237, US

(73) Assignee: Jacek Waksmundzki, Warsaw (PL)

(21) Appl. No.: 12/255,383

(22) Filed: Oct. 21, 2008

Related U.S. Application Data
(60) Provisional application No. 60/981,725, filed on Oct. 22, 2007.

(51) Int. Cl. H04M 3/42; G06Q 10/00

(52) U.S. Cl. 455/414.1; 705/5

(57) ABSTRACT

Reservation of services using, for example, a computer network based universal reservation system (CNBURS) is facilitated by the use of universal service codes (USCs). In one embodiment, a CNBURS enabled reservation scheduling process (100) includes receiving (110) a request from a service provider for a USC, generating (120) a USC uniquely associated for a period of time with an offer of available services, transmitting (130) the USC to the service provider, presenting (140) information about the offer of available services including the USC to a client by, for example, advertising (150) the services on a one-way communication media, receiving (160) an inquiry message including the USC from a client using the CNBURS, sending (170) a reservation message to the service provider, and sending (180) an acknowledgment message using the CNBURS to the client that includes information based on the USC confirming a reservation and/or informing the client about further steps to take to finalize a reservation.

### RELATED APPLICATION INFORMATION

This application claims priority from U.S. Provisional Application Ser. No. 60/981,725, entitled “UNIVERSAL SERVICE CODE FOR RESERVATIONS” filed on Oct. 22, 2007, which is incorporated by reference herein in its entirety.

### FIELD OF THE INVENTION

The present invention relates generally to facilitating the reservation of services offered by service providers, and more particularly to enhancing the functionality of both digital and analog one-way communication media with the possibility of making reservations for services in real time with the support of a return communication channel provided by two-way communication media.

### BACKGROUND OF THE INVENTION

Advertisements of available services may often be presented to potential clients via one-way analog and digital communication media. For example, a doctor's office might advertise the availability of appointments for medical services or a restaurant might advertise available dinner reservations via newspaper, magazine and/or television advertisements. In each of the foregoing examples, clients may utilize two-way communication media such as, for example, the Internet, a mobile phone, or an interactive television in order to make a reservation for a particular service. In doing so, the service provider may need the client to recount various details of the advertisement in order to correctly identify and reserve the particular service offered by the service provider. Providing such information can sometimes be challenging where the client no longer has access to the advertisement and receiving such information can be difficult if the reservations are being made via an intermediary, such as an online reservation system.

### SUMMARY OF THE INVENTION

The present invention provides for universal service codes (USCs) that enhance the functionality of both digital and analog one-way communication media (media without return channel capability) with the possibility of making reservations for services in real time with the support of a return communication channel provided by two-way communication media.

In one embodiment, a number of components and actors are provided including one internal component, one external component, and two actors. The one internal component is a universal service code provider, which generates and attributes a unique universal service code (USC) to an information and advertising campaign. The one external component is a reservation system. In one embodiment, the reservation system may be a computer network based universal reservation system (CNBURS). One example of an appropriate CNBURS is described in a separate United States Patent Application filed contemporaneously herewith entitled “COMPUTER NETWORK BASED UNIVERSAL RESERVATION SYSTEM” (which application claims priority from U.S. Provisional Application Ser. No. 60/981,738 filed Oct. 22, 2007), the entire disclosure of which is incorporated by reference herein.

The reservation system (e.g., a CNBURS) allows service providers to announce services that they provide, using one-way communication media. The two actors are a service provider and a client. The service provider provides services using the reservation system. The client is an individual or entity who wishes to make reservations for services (provided by a service provider and announced to clients by means of a reservation system or the like through one-way communication media) using two-way communication media connected to the reservation system.

A service provider using the USC supplied by the universal service code provider provides the clients with the possibility of starting a reservation process through one-way communication media by announcing the services combined with the unique USCs attributed to them. The clients, using the USC, communicate, by means of two-way communication media, with the reservation system in order to make reservations for services with the attributed USC visualized on one-way communication media.

In one embodiment, a USC may appear together with information on how access to a reservation system is granted. Information on how access to the reservation system is granted may include, for example, the number of a short message service (SMS) or multimedia message service (MMS) gateway on one-way communication media.

The present invention allows the services made available in the reservation system to be visualized over all media, including both one-way communication media (billboards, newspapers, etc.) and two-way communication media (cell phones, internet, interactive television, etc.), allowing to the clients to make reservations for such services.

The present invention also provides for enhanced functionality by introducing a system of recipients voting whereby it is possible to identify their current preferences as to the promotional and advertising campaigns conducted using the reservation system, and presentation over the system of only those services which arouse the greatest interest (e.g., the services that appear on the scrolling strip, and the voting on the subjects visible on screen).

The present invention also allows for straightforward directing of the client to the service provider. A USC facilitates conducting many promotional and advertising campaigns at the same time, through the intermediary of one visualization only. At the same time, a USC enables a much richer offer following the client's inquiry.

In one aspect, a method for facilitating the reservation of services by clients includes receiving a request from a service provider for a universal service code. A universal service code is generated that is uniquely associated for a period of time with an offer of available services by the service provider. The universal service code is transmitted to the service provider. Information about the offer of available services, including the universal service code, may be presented to a client by, for example, advertising the services on a one-way communication media. In this regard, the information about the offer of available services including the universal service code may enable the reservation with the support of two-way communication media. The method for facilitating the reservation of services by clients also includes receiving an inquiry message including the universal service code from a client and sending an acknowledgment message to the client. In this regard, the acknowledgment message may include information based on the universal service code included in the inquiry message.

In another aspect, a method for facilitating the reservation of services by clients using a computer network based universal reservation system (CNBURS) includes receiving a request from a service provider for a universal service code. A universal service code that is uniquely associated for a period of time with an offer of available services made using the CNBURS by the service provider is generated and transmitted to the service provider. Information about the offer of available services, including the universal service code, may be presented to a client by, for example, advertising the services on a one-way communication media. In this regard, the information about the offer of available services including the universal service code may enable the reservation with the support of two-way communication media. The method for facilitating the reservation of services by clients using a CNBURS also includes using the CNBURS to receive an inquiry message including the universal service code from a client and sending an acknowledgment message to the client using the CNBURS. In this regard, the acknowledgment message may include information based on the universal service code included in the inquiry message.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 is a block diagram providing an overview of one embodiment of a reservation scheduling process facilitated by the use of a USC; and

FIG. 2 is a flow chart of the steps of one embodiment of a USC generation process.

### DETAILED DESCRIPTION

A universal service code (USC) appears on one-way communication media together with information about how the access to the reservation system is granted (e.g., the number of a SMS/MMS gateway, the address of a web page, the address of a wireless application protocol (WAP) service, etc.). The code includes a series of marks that may be sequenced in a desired order. The USC is a code that is visible to the client during the campaign conducted by the advertising party. In the presently described embodiment, the reservation system is a CNBURS. However, other reservation systems different from a CNBURS may also be appropriate.

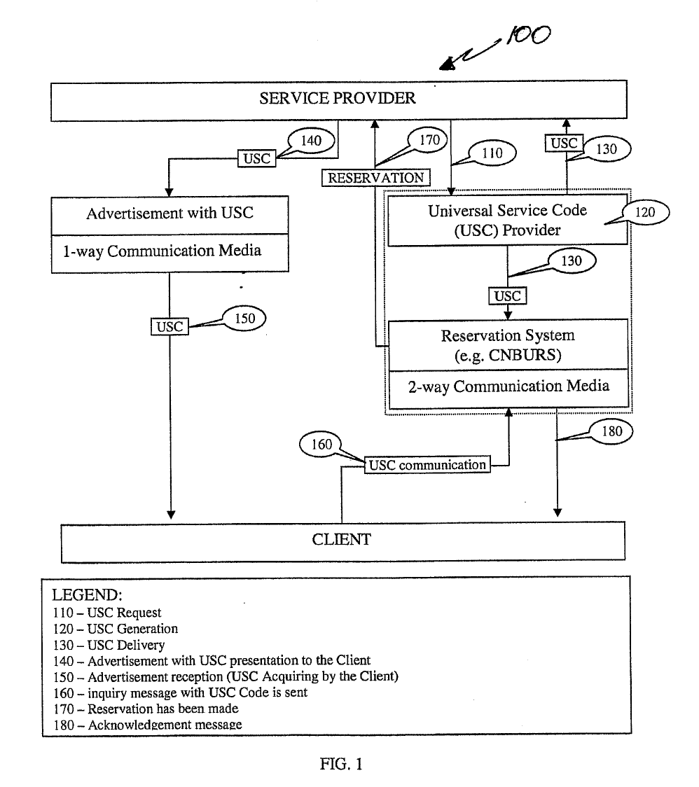

FIG. 1 depicts several steps (110 through 180) involved in one embodiment of a CNBURS enabled reservation scheduling process 100 between a client and a service provider that is facilitated by the use of USCs. The CNBURS reservation scheduling process 100 commences with step 110 wherein a request is received from a service provider for a universal service code. In step 120, a universal service code that is uniquely associated for a period of time with an offer of available services by the service provider is generated. In this regard, the offer of available services may be made using the CNBURS. In step 130, the universal service code is transmitted to the service provider and CNBURS.

In step 140, information about the offer of available services is presented to a client. In this regard, the information presented to the client includes the USC received by the service provider from the USC provider. The information may be presented in a number of manners including, for example, advertising 150 the services on a one-way communication media. In this regard, the information about the offer of available services includes the universal service code to enable the reservation with the support of two-way communication media. Advertising 150 the services on a one-way communication media may involve the use of various advertising media including, for example, broadcasting a television advertisement, broadcasting a radio advertisement, placing a billboard advertisement, and distributing a printed advertisement.

In step 160, an inquiry message including the USC is received from a client. In this regard, the inquiry message may be received using the CNBURS. The inquiry message may be transmitted with the support of two-way communication media using, for example, one or more of an SMS/MMS transmission, a web page accessed with a web browser, and a wireless application protocol (WAP) service.

In step 170, a reservation message is sent to the service provider. In step 180, an acknowledgment message is sent to the client. In this regard, the acknowledgment message includes information based on the USC included in the inquiry message. The information included in the acknowledgment message may confirm a reservation for a service from the service provider and/or may inform the client about further steps to take to finalize a reservation for a service from the service provider. The acknowledgment message may be sent to the client using the CNBURS.

In the CNBURS enabled reservation scheduling process 100, the steps of receiving 110 a request, generating 120 a universal service code, and transmitting 130 the universal service code may be accomplished using a USC provider system in communication with the CNBURS. Additionally, the steps of receiving 160 the inquiry message and transmitting 180 the acknowledgement message may be completed using a two-way communication media with the CNBURS being in communication with the USC provider system.

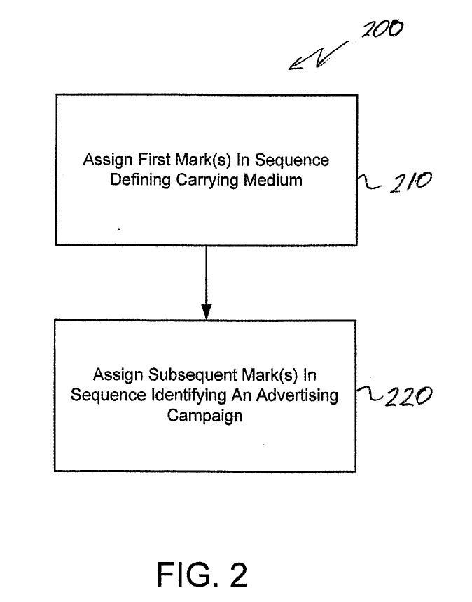

In one embodiment, the USC may include four alphanumeric marks. In other embodiments, the USC may include fewer or more alphanumeric marks. A four mark USC may be generated according to the following USC generation process 200 depicted in FIG. 2.

In step 210, a first mark in the sequence defining a carrying medium is assigned. In this regard, the first mark in the sequence may, for example, be a capital letter from the Roman alphabet assigned to the specific medium according the table below:

| | | | | | | | Analogue | Cell | | | |
|---|---|---|---|---|---|---|---|---|---|---|---|
| | | | | Daily | | Monthly | phone | phone | Promotional | | Billboards |
| TV | ITV | Internet | Radio | newspapers | Weeklies | magazines | systems | systems | leaflets | Other | (Outdoor) |
| A | B | C | D | E | F | G | H | I | J | L | K |

In step 220, the subsequent three marks in the sequence identifying an advertising campaign (e.g. “RFG”) are assigned. The subsequent three marks may be produced by computer software comprising a part of a universal service code provider system. The subsequent three marks in the USC sequence form a unique three-mark code that is one of the three-mark sequences of elements belonging to the set A consisting of n-elements (each element may appear repeatedly in a sequence).

As for the set A, the national alphabet appropriate for a given language, or national alphabet appropriate for the given language widened by the Arabic digits (0-9), may be employed. The unique three-mark code is hence the 3-words mathematical variation out of set A consisting of n-elements. The number of all k-words variations with repetitions out of n-elements set is equal to: V=n^{k}.

In the case of the Roman alphabet (twenty six letters altogether, without digraphs and diacritical marks) the number of possible unique three-mark codes is as follows:

V=26³=17576

When widening the Roman alphabet by the Arabic digits the number of possible codes is as follows:

V=(26+10)³=46656

Thus, when using the Roman alphabet (widened with the Arabic digits) it is possible, in the given period of time (e.g. one month), to make entries to the database with a maximum of 46656 unique codes identifying advertising campaigns.

In case of the Cyrillic alphabet (thirty one letters altogether with no harsh or soft marks) the number of possible unique three-mark codes is as follows:

V=31³=29791

When widening the alphabet by the Arabic digits the number of possible codes is as follows:

V=(31+10)³=68921

The USC may be presented to clients in a number of manners using various carrying media including, but not limited to, television, radio, billboards, and printed material. For the individual kinds of media (e.g., television, radio, billboards, printed material), the USC may, for example, be introduced as follows.

For television without a return communication channel (e.g., analog television), the USC may be introduced in conjunction with broadcasting of commissioned spot advertising (e.g., a rock concert). Once the spot is broadcast the numbers of an SMS/MMS gateways are shown on screen accompanied by the four-mark USCs which are assigned to the service advertised. When watching the given spot advertising, the client may send an SMS/MMS message including the USC code shown on screen to the number of the SMS/MMS gateways shown on screen in order to e.g., reserve a concert ticket including the desired ticket class, and a seat number in a concert hall. The CNBURS acknowledges, by return SMS/MMS message, inquiry reception and provides the client with the information regarding where and at what time the concert entry ticket is to be collected. In the case of taking advantage of other media having the return channel possibility (or the combination thereof), the solutions are applied permitting sending information to and from CNBURS in a way specific to them.

For advertising billboards, an advertising campaign conductor places the advertisements on the billboards, accompanied by the USC comprising information on the service advertised and billboard(s) location(s). The range of code signs is provided by the universal service code provider. The executive fixing the posters introduces the code to the database stored on a palmtop or via a code signs reader (reading of a code from the etiquette attached to codes list). This way, the code sign is attributed to the billboard location. The prospective client sends to the CNBURS the code perceived, using e.g., WAP page shown on billboard. The CNBURS acknowledges inquiry reception and provides the client with the combination of unique service attributes allowing the client to fix reservation details (the term, the volume, the campaign, etc.). The client, while engaged in such interactive operation, fixes further reservation details and sends it to the CNBURS in order to make a reservation. In the case of taking advantage of other media having the return channel possibility (or the combination thereof), the solutions are applied permitting sending information to and from CNBURS in a way specific to them.

For newspapers, weeklies, leaflets and the like, an advertising campaign conductor publishes the advertisements accompanied by the USC comprising information on the service advertised and advertisements locations (e.g. the name of newspaper, where it was announced). The range of code signs is provided by the universal service code provider. The prospective client sends to the CNBURS the code perceived using e.g., a web page address provided by the advertising party. The CNBURS acknowledges inquiry reception and provides the client with the combination of unique service attributes allowing the client to fix reservation details (the term, the volume, the campaign, etc.). The client, while engaged in such interactive operation, fixes further reservation details and sends it to the CNBURS in order to make a reservation. In the case of taking advantage of other media having the return channel possibility (or the combination thereof), the solutions are applied permitting sending information to and from CNBURS in a way specific to them.

For radio, an advertising campaign conductor publishes the advertisements accompanied by the USC comprising information on the service advertised and advertisements locations (e.g., a radio program where it was announced). The range of code signs is provided by the universal service code provider. During advertisement airing over the radio, the coherent voice message with the appropriate code is announced. The prospective client sends the code, via e.g., SMS/MMS, to the number of an SMS/MMS gateway advised with the advertisement or fills it in a form exposed on the web page (or WAP, etc.) provided by the advertising party, using e.g. the decoding device of the interactive television in order to establish communication with the CNBURS. The CNBURS acknowledges inquiry reception and provides the client with the combination of unique service attributes allowing the client to fix reservation details (the term, the volume, the campaign, etc.). The client, while engaged in such interactive operation, fixes further reservation details and sends it to the CNBURS in order to make a reservation with the support of solutions permitting sending information to and from CNBURS in a way specific to the given medium or the combination of media used to enable the return channel possibility.

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A method for facilitating the reservation of services by clients, said method comprising the steps of:
receiving a request from a service provider for a universal service code;
generating a universal service code that is uniquely associated for a period of time with an offer of available services by the service provider;
transmitting the universal service code to the service provider;
receiving an inquiry message including the universal service code from a client; and
sending an acknowledgment message to the client, wherein the acknowledgment message includes information based on the universal service code included in the inquiry message.

2. The method of claim 1 wherein in said step of sending, the information included in the acknowledgment message confirms a reservation for a service from the service provider.

3. The method of claim 1 wherein in said step of sending, the information included in the acknowledgment message informs the client about further steps to take to finalize a reservation for a service from the service provider.

4. The method of claim 1 further comprising the step of:
presenting information about the offer of available services to a client, wherein the information includes the universal service code.

5. The method of claim 4 wherein said step of presenting comprises:
advertising the services on a one-way communication media, wherein the information about the offer of available services includes the universal service code enabling the reservation with the support of two-way communication media.

6. The method of claim 5 wherein the support of two-way communication media includes using one or more of an SMS/MMS transmission, a web page accessed with a web browser, and a wireless application protocol (WAP) service.

7. The method of claim 1 wherein the inquiry message comprises a message to a reservation system and wherein said method further comprises the step of:
transmitting the inquiry message with the support of two-way communication media.

8. The method of claim 7 wherein the reservation system comprises a CNBURS.

9. The method of claim 7 wherein the support of two-way communication media includes using one or more of an SMS/MMS transmission, a web page accessed with a web browser, and a wireless application protocol (WAP) service.

10. The method of claim 5 wherein said step of advertising comprises using at least one of the following carrying media:
broadcasting a television advertisement;
broadcasting a radio advertisement;
placing a billboard advertisement; and
distributing a printed advertisement.

11. The method of claim 1 wherein said steps of receiving an inquiry message and transmitting an acknowledgement message are completed using a two-way communication media.

12. The method of claim 1 wherein said steps of receiving a request, generating a universal service code, and transmitting the universal service code are accomplished using a universal service code provider system in communication with a reservation system.

13. The method of claim 12 wherein the reservation system comprises a CNBURS.

14. The method of claim 1 wherein said steps of receiving an inquiry message and sending an acknowledgment message are accomplished using a reservation system in communication with a universal service code provider system.

15. The method of claim 14 wherein the reservation system comprises a CNBURS.

16. The method of claim 1 wherein said step of generating a universal service code comprises:
combining one or more marks into a sequence of marks.

17. The method of claim 16 wherein in said step of combining one or more marks, the marks are selected from any set of marks consisting of alphabetical letters, numerals, or special marks.

18. The method of claim 1 further comprising:
sending a reservation message to the service provider.

19. A method for facilitating the reservation of services by clients using a computer network based universal reservation system (CNBURS), said method comprising the steps of:
receiving a request from a service provider for a universal service code;
generating a universal service code that is uniquely associated for a period of time with an offer of available services by the service provider, wherein the offer of available services is made using the CNBURS;
transmitting the universal service code to the service provider;
receiving an inquiry message including the universal service code from a client, wherein the inquiry message is received using the CNBURS; and
sending an acknowledgment message to the client, wherein the acknowledgment message includes information based on the universal service code included in the inquiry message, and wherein the acknowledgment message is sent using the CNBURS.

20. The method of claim 19 wherein in said step of sending, the information included in the acknowledgment message confirms a reservation for a service from the service provider.

21. The method of claim 19 wherein in said step of sending, the information included in the acknowledgment message informs the client about further steps to take to finalize a reservation for a service from the service provider.

22. The method of claim 19 further comprising the step of:
presenting information about the offer of available services to a client, wherein the information includes the universal service code.

23. The method of claim 22 wherein said step of presenting comprises:
advertising the services on a one-way communication media, wherein the information about the offer of available services includes the universal service code enabling the reservation with the support of two-way communication media.

24. The method of claim 23 wherein the support of two-way communication media includes using one or more of an SMS/MMS transmission, a web page accessed with a web browser, and a wireless application protocol (WAP) service.

25. The method of claim 19 further comprising the step of:
transmitting the inquiry message with the support of two-way communication media.

26. The method of claim 25 wherein the support of two-way communication media includes using one or more of an SMS/MMS transmission, a web page accessed with a web browser, and a wireless application protocol (WAP) service.

27. The method of claim 23 wherein said step of advertising comprises using at least one of the following carrying media:
broadcasting a television advertisement;
broadcasting a radio advertisement;
placing a billboard advertisement; and
distributing a printed advertisement.

28. The method of claim 19 wherein said steps of receiving an inquiry message and transmitting an acknowledgement message are completed using a two-way communication media.

29. The method of claim 19 wherein said steps of receiving a request, generating a universal service code, and transmitting the universal service code are accomplished using a universal service code provider system in communication with the CNBURS.

30. The method of claim 19 wherein in said steps of receiving an inquiry message and sending an acknowledgment message, the CNBURS is in communication with a universal service code provider system.

31. The method of claim 19 wherein said step of generating a universal service code comprises:
combining one or more marks into a sequence of marks.

32. The method of claim 31 wherein in said step of combining one or more marks, the marks are selected from any set of marks consisting of alphabetical letters, numerals, or special marks.

33. The method of claim 19 further comprising:
sending a reservation message to the service provider.
